(19) United States
(12) Patent Application Publication
(10) Pub. No.: US 2014/0337095 A1
(43) Pub. Date: Nov. 13, 2014

(54) Data Processing System

(71) Applicants: Hong Huie, Edina, MN (US); Lenny Huie, Edina, MN (US)

(72) Inventors: Hong Huie, Edina, MN (US); Lenny Huie, Edina, MN (US)

(21) Appl. No.: 13/471,382

(22) Filed: May 14, 2012

Related U.S. Application Data
(60) Provisional application No. 61/486,069, filed on May 13, 2011.

(51) Int. Cl. G06Q 30/02

(52) U.S. Cl. CPC G06Q 30/0202
USPC 705/7.31

(57) ABSTRACT

The present system is a data base and communications system which collects relevant consumer data and provides forecasts and projections to merchandisers and provides focused marketing efforts to merchandisers with at least one object being to foster consumer loyalty.

### CROSS REFERENCE TO RELATED APPLICATIONS

The application listed below is the only application related to this application. This application claims benefit of the earlier filing date under 35 USC 119(e) of provisional application No. 61/486,069filed on May 12, 2011.

### STATEMENT REGARDING FEDERALLY SPONSORED RESEARCH OR DEVELOPMENT

No invention claimed in this application was made under Federally sponsored research or development.

### THE NAMES OF THE PARTIES TO A JOINT RESEARCH AGREEMENT

Not Applicable

### REFERENCE TO A SEQUENCE LISTING

Not Applicable

### BACKGROUND OF THE INVENTION

1. Field of the Invention

The present invention pertains to data base systems which make use of the internet and other communications systems. An object of the present system is to provide data and communications engendering customer loyalty.

2. Description of Related Art

Systems which use the internet and other communications systems to collect and manage data are known in the art. Published Patent application; U.S.20090140035A1 by Miller, and U.S.20110082747A1 by Khan et al, are typical. The scope and focus of the present invention distinguish it from the known art.

### BRIEF SUMMARY OF THE INVENTION

The present system is a database and communications system which collects relevant consumer data and provides forecasts and projections to merchandisers and provides focused marketing efforts to merchandisers with at least one object being to foster consumer loyalty.

### BRIEF DESCRIPTION OF THE SEVERAL VIEWS OF THE DRAWING

FIG. 1 is an Architecture Diagram of the Data Processing System.

FIG. 2 is a Convergence Diagram of the Data Processing System

### DETAILED DESCRIPTION OF THE INVENTION

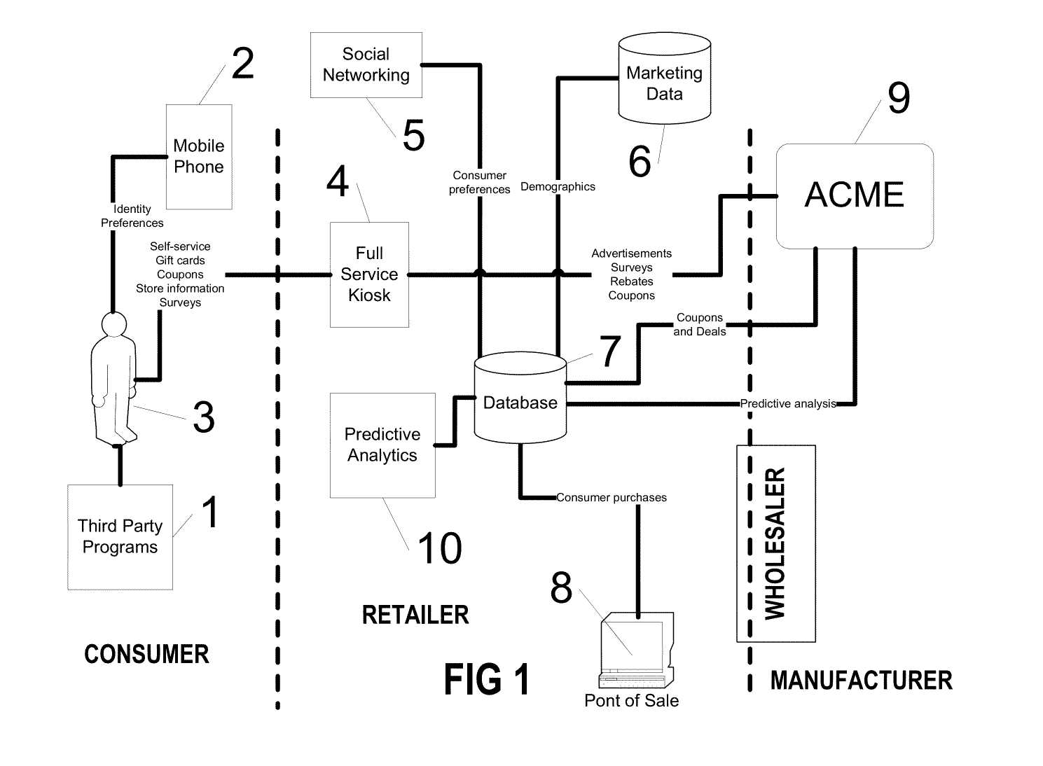

Referring to FIG. 1, the following are lists of data elements expected, but not limited to, in the data paths.
The identification of consumer 3 preferences is achieved by collecting the history of individual consumer 3 purchase histories from Purchase lists, electronic purchases, downloaded deals and coupons, social networking interactions, and marketing lists.
Mobile application 2 is able to use GPS to determine consumer 3 location. If GPS is not used, mobile application 2 displays coupons and deals for any location. If GPS is used, mobile application 2 displays coupons and deals near consumer's 3 location.
Mobile application 2 displays coupons, deals, and advertisements. Mobile application 2 has a feature for consumer 3 to electronically reserve coupons and deals. Mobile application 2 also has a feature for consumer 3 to share the coupons and deals on social networking sites Facebook, Twitter, Google Buzz, MySpace, and others.
Mobile application 2 includes a shopping list for consumer 3.
Mobile application 2 has the option to conduct surveys.
Kiosk 4 displays coupons, deals, and advertisements. If consumer 3 is logged into the kiosk, then the displayed coupons, deals, and advertisements are based upon consumer's 3 preferences. The displayed coupons, deals, and advertisements on the kiosk are based on consumer preferences, demographics, predictive analysis, and consumer purchases
Kiosk 4 has the optional ability for consumer 3 to purchase gift cards. Also, kiosk 4 has the optional ability to print and dispense gift cards.
Kiosk 4 has the option to conduct surveys.
Consumer purchases from any point of sale device that is part of the present system program will be saved into the database 8. Purchase information includes, SKU, production description, transaction date and time, item price, and consumer's 3 telephone number or other consumer identifier.
The present system has the option to integrate with third party programs 1. Third party programs include loyalty programs, incentive programs, referral programs, affiliate programs, and similar types of programs. The present system provides deals and coupons to those third party programs 1. The present system also inputs deals and coupons from those third party programs 1. The present system exchanges preference and demographic information with the third party programs 1.
Consumer 3 is an individual interacting with The present system. Consumer 3 receives coupons and deals via the present system mobile app 2. Consumer 3 shares coupons and deals on social networking sites 5. Consumer 3 reserves coupons and deals on mobile app 2.
Marketing and demographic data 6 are third party marketing data providers. Marketing and demographic data includes, but not limited to, consumer's 3 annual income, age, marital status, and whether consumer 3 has children. The present system uses the marketing and demographic data 6 to refine the predictive analytics 10. Marketing and demographic information is input into database 7.
Point of sale 8 information is input into The present system database 7. This includes all sales transaction information for consumer 3.
Manufacturer 9 provides coupons and deals to The present system. Manufacture 9 coupons and deals are input into the present system database 7. Manufacture 9 also provides coupons, deals, surveys, and rebates to be displayed on The present system kiosk 4.
The present system database 7 provides predictive analysis data to manufacturer 9 for manufacture 9 to determine the specific coupons or deals to provide The present system.
The present system predictive analytics 10 determines the specific coupons and deals to offer consumer 3. Predictive analytics 10 takes inputs, if available, from data stored in database 7.
Database 7 stores consumer preferences from social networking sites 5, demographic data from marketing data 6, coupons and deals from manufacturers 9, point of sale purchase data from point of sale 6, and predictive analytics data from The present system predictive analytics 10. Also, if consumer 3 has a shopping list on mobile application 2, then database 7 stores the shopping list items.

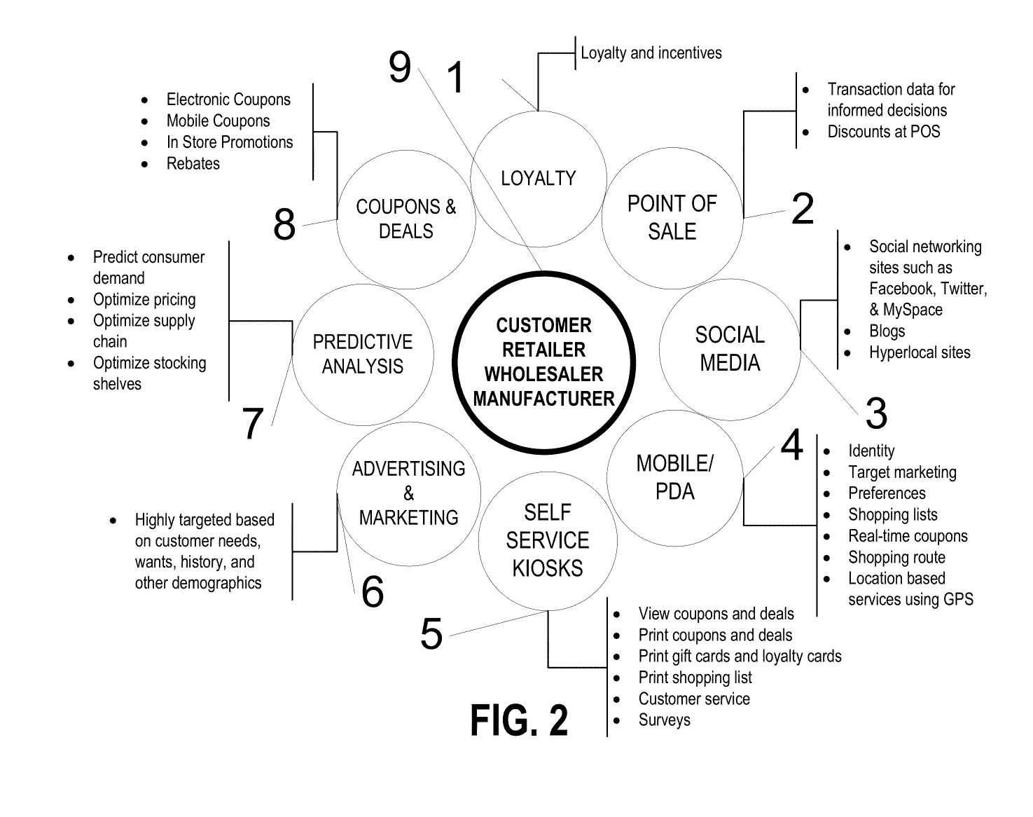

Referring to FIG. 2, the following are lists of data elements expected, but not limited to, in the data paths.
Loyalty 1 is a loyalty and incentives platform.
Point of sale 2 contains sales transaction data for consumers. The sales transaction data is input into the present system system.
Social media 3 sites includes Facebook, Twitter, Myspace, blogging sites, hyperlocal sites, and other similar sites. The present system provides ability for consumers to share deals and coupons on social media sites. Consumers are incented to share.
Mobile/PDA 4 includes mobile devices and smart phones. The present system mobile application runs on mobile/PDA 4. The present system mobile application has ability to verify identity of user, target marketing for advertisers, manufacturers, restaurants, and other retailers to deliver coupons and deals to and individual consumer based on the consumer's preferences, demographics, and purchase history. The present system mobile application also has the ability to input an individual consumer's preferences and to track an individual consumer's preferences. The present system mobile application includes a shopping list for industries in which a shopping list is utilized. The present system mobile application has the ability to display coupons and deals provided by manufacturers and retailers, in real-time. The present system mobile application has the optional ability to show the shopping route for an individual consumer. The Allavannt mobile application also has the optional ability to provide location-based services using GPS.
Using Kiosk 5, an individual consumer has the ability to view coupons and deals, print coupons and deals, print gift cards and loyalty cards, and print the individual consumer's shopping list. Also, retailers and manufacturers can use kiosk 5 to provide customer service functions, display advertisements, and conduct surveys.
The present system is a platform to allow advertising and marketing 6 on kiosk 5. The advertisements and marketing 6 can be highly targeted, based on consumer needs, wants, preferences, purchase history, and other demographics. The present system contains the information regarding customer needs, wants, preferences, purchase history, and other demographics that advertisers and marketers may use, contingent upon agreements, terms, and conditions.
The present system contains predictive analysis 7 to predict consumer demand, optimize pricing, optimize retailer and manufacturer supply chain, optimize stocking shelves at retailers and inventory at manufacturers, and determine the selected coupons and deal to offer individual consumers.
The present system delivers electronic coupons and deals 8 to kiosk 5, mobile applications, and websites.
The present system integrates the participation of consumers, retailers, wholesalers, and manufactures 9 in a loyalty and incentives program.

We claim:

1) a data processing system comprising:
a) a database;
b) a set of consumer data collection devices for collecting consumer demographic and purchase preference data;
c) a set of retailer data collection devices for collection of retailer product data; and
d) a set of consumer purchase lists, said lists tailored to a consumer identified via said consumer data collection devices, said lists optimized for said consumer based on said consumer demographic and purchase preference data and retailer product data.
